(19) United States
(12) Patent Application Publication
(10) Pub. No.: US 2026/0360315 A1
(43) Pub. Date: Nov. 12, 2026

(54) STAGE CIRCUIT, DISPLAY DEVICE INCLUDING THE SAME, AND ELECTRONIC DEVICE INCLUDING THE SAME

(71) Applicant: Samsung Display Co., Ltd., Yongin-si (KR)

(72) Inventors: Won Jun LEE, Yongin-si (KR); Sung Min SON, Yongin-si (KR); Min Ji KIM, Yongin-si (KR); Geum Ju MOON, Yongin-si (KR)

(73) Assignee: Samsung Display Co., Ltd., Yongin-si (KR)

(21) Appl. No.: 19/381,743

(22) Filed: Nov. 6, 2025

(30) Foreign Application Priority Data
May 9, 2025 (KR) 10-2025-0060702

(51) Int. Cl. G09G 3/3266; G09G 3/3233

(52) U.S. Cl. CPC G09G 3/3266; G09G 3/3233; G09G 2300/0842; G09G 2310/0286; G09G 2310/08; G09G 2330/021

(57) ABSTRACT

Example embodiments of the present disclosure may provide a stage circuit including an input circuit configured to input a first signal in response to a clock signal, a signal processing circuit configured to switch an electrical connection in response to a voltage of a first node, and switch an electrical connection in response to a voltage of a third node, an output circuit configured to switch an electrical connection in response to a voltage of a second node, and switch an electrical connection in response to the voltage of the third node, and a stabilizing circuit configured to switch an electrical connection in response to the voltage of the first node or the voltage of the third node, and switch an electrical connection in response to a voltage of the fourth node, wherein the fourth node and the third node are electrically connected.

### CROSS-REFERENCE TO RELATED APPLICATION

This application claims priority to Korean Patent Application No. 10-2025-0060702, filed on May 9, 2025, and all the benefits accruing therefrom under 35 U.S.C. § 119, the content of which in its entirety is herein incorporated by reference.

### BACKGROUND

Example embodiments of the present disclosure relate to a stage circuit, a display device including the same, and electronic devices including the same.

With the development of information technology, the importance of display devices as a connection medium between users and information is becoming increasingly important. In response to this, the use of display devices such as liquid crystal display devices, organic light emitting display devices, and the like is increasing.

The display device may include stage circuits for sequentially generating injection signals. The stage circuits may output a signal (e.g., an output signal). In order to output a signal at a stable level, it is desired to maintain a stable magnitude of voltage applied to the nodes within the stage circuit.

### SUMMARY

Example embodiments provide a stage circuit capable of stably controlling an output signal, an indicating device comprising the same, and an electronic device comprising the same.

Example embodiments of the present disclosure may provide a stage circuit including an input circuit configured to input a first signal from a first input terminal to a first node in response to a clock signal input to a second input terminal, a signal processing circuit configured to switch an electrical connection between a third input terminal and a second node in response to a voltage of the first node, and switch an electrical connection between a fourth input terminal and the second node in response to a voltage of a third node, the third node being electrically connected to the first node, an output circuit configured to switch an electrical connection between the third input terminal and an output terminal in response to a voltage of the second node, and switch an electrical connection between the fourth input terminal and the output terminal in response to the voltage of the third node, and a stabilizing circuit configured to switch an electrical connection between the first input terminal and a fourth node in response to the voltage of the first node or the voltage of the third node, and switch an electrical connection between the second input terminal and a fifth node in response to a voltage of the fourth node, wherein the fourth node and the third node are electrically connected.

Example embodiments of the present disclosure may provide a display device including a display panel including a plurality of pixels, a scan driving circuit comprising a plurality of stage circuits, the plurality of stage circuits configured to supply a scan signal to the plurality of pixels, a data driving circuit configured to supply a plurality of data signals to the plurality of pixels, and a timing controller configured to control the scan driving circuit and the data driving circuit. At least one of the plurality of stage circuits comprises an input circuit configured to input a first signal from a first input terminal to a first node in response to a second signal input to a second input terminal, a signal processing circuit configured to switch an electrical connection between a third input terminal and a second node in response to a voltage of the first node, and switch an electrical connection between a fourth input terminal and the second node in response to a voltage on a third node, the third node being electrically connected to the first node, an output circuit configured to switch an electrical connection between the third input terminal and an output terminal in response to a voltage of the second node, and switch an electrical connection between the fourth input terminal and the output terminal in response to a voltage of the third node, and a stabilizing circuit configured to switch an electrical connection between the first input terminal and a fourth node in response to the voltage of the first node or the voltage of the third node, and switch an electrical connection between the second input terminal and a fifth node in response to the voltage of the fourth node. The fourth node and the third node are electrically connected.

Example embodiments of the present disclosure may provide an electronic device including a display device comprising a plurality of pixels configured to display an image, and a plurality of stage circuits configured to supply a scan signal to the plurality of pixels; and a processor configured to control the display device. At least one of the plurality of stage circuits comprises an input transistor configured to input a first signal from a first input terminal to a first node in response to a second signal input to a second input terminal, a signal processing circuit configured to switch an electrical connection between a third input terminal and a second node in response to a voltage of the first node, and switch an electrical connection between a fourth input terminal and the second node in response to a voltage of a third node, the third node being electrically connected to the first node, an output circuit configured to switch an electrical connection between the third input terminal and an output terminal in response to a voltage of the second node, and switch an electrical connection between the fourth input terminal and the output terminal in response to the voltage of the third node, and a stabilizing circuit configured to switch an electrical connection between the first input terminal and a fourth node in response to the voltage of the first node or the voltage of the third node, and switch an electrical connection between the second input terminal and a fifth node in response to a voltage of the fourth node, and wherein the fourth node and the third node are electrically connected.

### BRIEF DESCRIPTION OF THE DRAWINGS

FIG. 1 is a system block diagram of an electronic device according to some example embodiments of the present disclosure.

FIG. 2 is an equivalent schematic of a pixel according to some example embodiments of the present disclosure.

FIG. 3 is an equivalent schematic of a pixel according to some example embodiments of the present disclosure.

FIG. 4 is a block diagram of a scan driving circuit according to some example embodiments of the present disclosure.

FIG. 5 is an equivalent schematic of a stage circuit according to some example embodiments of the present disclosure.

FIG. 6 is an equivalent schematic of a stage circuit according to some example embodiments of the present disclosure.

FIG. 7 is an equivalent schematic of a stage circuit according to some example embodiments of the present disclosure.

FIG. 8 is an equivalent schematic of a stage circuit, according to some example embodiments of the present disclosure.

FIG. 9 is an equivalent schematic of a stage circuit according to some example embodiments of the present disclosure.

FIG. 10 is an equivalent schematic of a stage circuit according to some example embodiments of the present disclosure.

FIG. 11 is a timing diagram of a driving method according to some example embodiments of the present disclosure.

FIGS. 12 to 19 are drawings illustrating an equivalent schematic of a stage circuit according to some example embodiments in association with a timing diagram of a driving method.

FIG. 20 is a block diagram of an electronic device according to some example embodiments of the present disclosure.

FIG. 21 is a schematic diagram of an electronic device according to various example embodiments.

### DETAILED DESCRIPTION

Hereinafter, with reference to the accompanying drawings, various example embodiments of the present invention will be described in detail to facilitate practice by one having ordinary skill in the art to which the invention belongs. The invention may be implemented in many different forms and is not limited to the embodiments described herein.

In order to clearly illustrate the present invention, portions not pertinent to the description have been omitted, and identical or similar components have been designated by the same reference numerals throughout the specification. Accordingly, the aforementioned reference numerals may be used in other drawings.

Further, the size and thickness of each configuration shown in the drawings is arbitrarily indicated for ease of illustration and the invention is not necessarily limited to that shown. Thicknesses may be exaggerated in the drawings to clearly represent the various layers and regions.

Also, when “identical” is used in the description, it may mean “substantially identical”, i.e., identical to the extent that a person of ordinary skill would be led to believe that they are identical. Other expressions may also omit “substantially”.

Terms such as “first”, “second” and the like may be used to describe various components, but the components are not to be limited by such terms. These terms are used only for the purpose of distinguishing one component from another. For example, a first component may be named a second component, and similarly, a second component may be named a first component, without departing from the scope of the present invention. The singular expression includes the plural unless the context clearly indicates otherwise.

The terms “below”, “under”, “on”, “above” and the like are used to describe the relationship of the configurations shown in the drawings. These terms are relative and are described with reference to the direction shown in the drawings.

Unless otherwise defined, all terms used herein (including technical and scientific terms) shall have the same meaning as commonly understood by those skilled in the art to which the present invention belongs. In addition, terms such as those defined in commonly used dictionaries are to be interpreted as having a meaning consistent with their meaning in the context of the relevant art and are expressly defined herein, unless they are interpreted in an idealized or overly formal sense.

The terms “comprising” or “having” and the like are intended to designate the presence of the features, numbers, steps, actions, components, parts, or combinations thereof described in the specification and are not to be understood as precluding the possibility of the presence or addition of one or more other features, numbers, steps, actions, components, parts, or combinations thereof.

Some example embodiments of the present disclosure will now be described in detail with reference to the accompanying drawings.

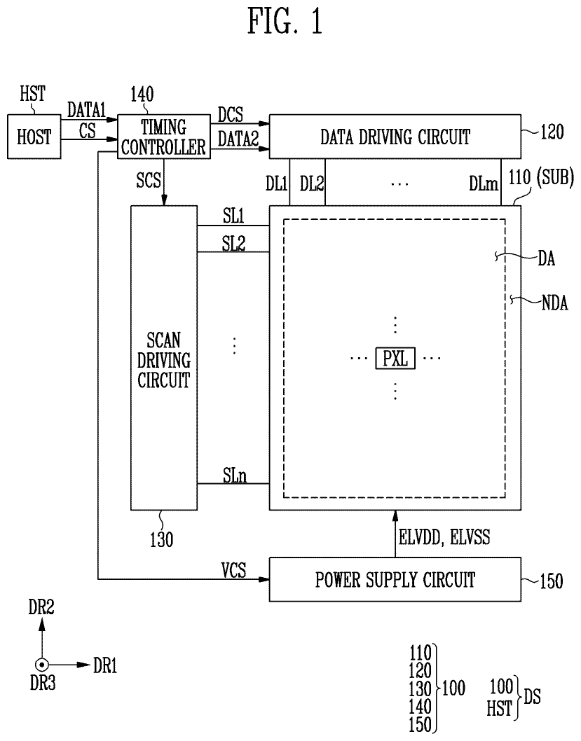

FIG. 1 is a system block diagram of an electronic device DS according to some example embodiments of the present disclosure.

An electronic device DS according to some example embodiments of the present disclosure may include a display device 100 and a host HST.

Referring to FIG. 1, a display device 100 according to some example embodiments of the present disclosure may include a display panel 110, a data driving circuit 120, a scan driving circuit 130, a timing controller 140, and a power supply circuit 150.

The display panel 110 may include a substrate SUB. The display panel 110 may include a display area DA in which a plurality of pixels PXL are located on the substrate SUB, and a non-display area NDA surrounding the display area DA. The display panel 110 (or, alternatively, the display area DA) may include a plurality of data lines DL1 to DLm (where m is an integer of 2 or more) and a plurality of scan lines SL1 to SLn (where n is an integer of 2 or more) electrically connected to the plurality of pixels PXL. The display panel 110 may include one or more power lines configured to apply a power supply voltage to the plurality of pixels PXL. The non-display area NDA may be located in a peripheral area of the display area DA (e.g., an edge area of the display area DA). The non-display area NDA may include one or more pads, and a plurality of data lines DL1 to DLm may be supplied with data voltages, power voltages, etc. via the pads. Light emitted from the pixel PXL may be directed in a third direction DR3.

The display panel 110 may be formed as a flat surface, but example embodiments of the present disclosure are not limited thereto. For example, the display panel 110 may include curved surfaces formed at the left and right ends. The curved surfaces may have a constant curvature, or may have a varying curvature. In addition, the display panel 110 may be flexibly formed to be bent, curved, bent, folded, or curled.

In some example embodiments, the substrate SUB may include a rigid glass substrate. However, example embodiments of the present disclosure are not limited thereto and may include a flexible plastic substrate. For example, the plastic substrate may be implemented as a polyimide (PI) substrate. In other embodiments, the substrate SUB may be implemented as a silicon substrate.

The plurality of data lines DL1 to DLm may extend in a first direction from the display panel 110. The first direction may be, for example, the second direction DR2. The plurality of data lines DL1 to DLm may extend from the display panel 110 in the second direction DR2 (e.g., generally in the second direction DR2). The second direction DR2 may be, for example, a direction across the top to bottom of the display panel 110, but example embodiments of the present disclosure are not limited thereto.

The plurality of scan lines SL1 to SLn may extend in one direction from the display panel 110. The one direction may be, for example, the first direction DR1. The plurality of scanning lines SL1 to SLn may extend from the display panel 110 in the first direction DR1 (e.g., generally in the first direction DR1). The first direction DR1 may be in a different direction than the second direction DR2, but example embodiments of the present disclosure are not limited thereto. The first direction DR1 may be, for example, a direction across the left to right side of the display panel 110.

The data driving circuit 120 may be configured to supply data voltages to the plurality of data lines DL1 to DLm. The data driving circuit 120 may generate a data voltage based on the second image data DATA2 and the data driving circuit control signal DCS, and may output the generated data voltage to the plurality of data lines DL1 to DLm in a timed manner. The data driving circuit control signal DCS may include, for example, a source start pulse (SSP) signal, a source shift clock (SSC) signal, a source output enable (SOE) signal, and the like.

The data driving circuit 120 may be implemented as an integrated circuit (e.g., a source driver integrated circuit (SDIC)) formed separate from the display panel 110, or it may be formed with the display panel 110 and formed on at least a portion of the non-display area NDA of the display panel 110.

The scan driving circuit 130 is configured to output scan signals to the plurality of scan lines SL1 to SLn in response to a scan driving circuit control signal SCS. The scan driving circuit control signal SCS may include a start signal to indicate the start of a frame, a horizontal synchronization signal to output the scan signals in time with the timing of the data voltage being applied, and the like.

The scan driving circuit 130 may be implemented as an integrated circuit (e.g., a gate driving integrated circuit (GDIC)) formed separately from the display panel 110, or it may be formed with the display panel 110 and formed in at least a portion of the non-display area NDA of the display panel 110.

The power supply circuit 150 may be configured to output a constant voltage at a constant voltage level. The power supply circuit 150 may output a power supply voltage (e.g., a first power supply voltage ELVDD, a second power supply voltage ELVSS, etc.) that is supplied to the display panel 110. According to some example embodiments, the power supply circuit 150 may output a voltage (e.g., gate high voltage, gate low voltage, etc.) supplied to the scan driving circuit 130. According to some example embodiments, the power supply circuit 150 may output a voltage (e.g., a gamma voltage, etc.) supplied to the data driving circuit 120. The power supply circuit 150 may include, for example, a regulator (e.g., low dropout (LDO) regulator, etc.). The power supply circuit 150 may be implemented, for example, as a power management integrated circuit (PMIC). The power supply circuit 150 may be configured to output a power supply voltage to the power lines in response to a power supply circuit control signal VCS.

The timing controller 140 may be configured to control the data driving circuit 120, the scan driving circuit 130, the power supply circuit 150, and the like. The timing controller 140 may generate and output control signals DCS, SCS, VCS for controlling the data driving circuit 120, the scan driving circuit 130, and the power supply circuit 150 based on control signals CS (e.g., synchronization signals, clock signals, data enable signals, etc.) received via the host HST. In accordance with some example embodiments, the timing controller 140 may generate synchronization signals, data enable signals, and the like therein based on control signals CS input from the host HST (e.g., information about the drive frequency (or frame rate) of the image displayed on the display panel 110).

The timing controller 140 may receive input first image data DATA1 from the host HST and may sort the input first image data DATA1 by pixel row. The timing controller 140 may convert the input first video data DATA1 to a preset interface (e.g., low voltage differential signaling (LVDS), display port (DP), embedded display port (eDP), etc.). The second image data DATA2 output by the timing controller 140 to the data driving circuit 120 may be converted internally in the timing controller 140 according to the above preset interface.

In accordance with some example embodiments, the timing controller 140 may be disposed within the display device 100 as a logic type. In accordance with some example embodiments, the timing controller 140 may be disposed within the display device 100 as a processor type. The timing controller 140 may include one or more memories (e.g., registers, etc.).

The host HST may include a set-top box, an application processor (AP), or the like. In some examaple embodiments, the host HST may be a configuration external to the display device 100 that is not included in the display device 100. In some example embodiments, the host HST may be mounted within the display device 100. Sending and receiving of the first image data DATA1 and control signals CS may be accomplished via an interface between the host HST and the display device 100. The interface may be, for example, a serial programming interface (SPI), an inter integrated circuit (I2C), a mobile industry processor interface (MIPI), or the like. However, example embodiments of the present disclosure are not limited thereto.

In FIG. 1, the circuits that supply signals, voltages, and the like to the display panel 110 are merely categorized by function. For example, the data driving circuit 120 and the timing controller 140 may be formed within one integrated circuit. The data driving circuit 120 and the timing controller 140 may be categorized by function within one integrated circuit within the display device 100.

The display device 100 according to some example embodiments of the present disclosure can be used as a display screen for a variety of products such as televisions, laptops, monitors, billboards, Internet of Things (IoT) devices, and other products such as portable electronic devices such as mobile phones, smart phones, tablet personal computers, and smart watches, watch phones, watch phones, mobile communication terminals, electronic notebooks, e-books, portable multimedia players (PMP), navigation systems, ultra-mobile personal computers (UMPC), and the like, as well as portable electronic devices such as smart watches, smart watches, watch phones, and the like.

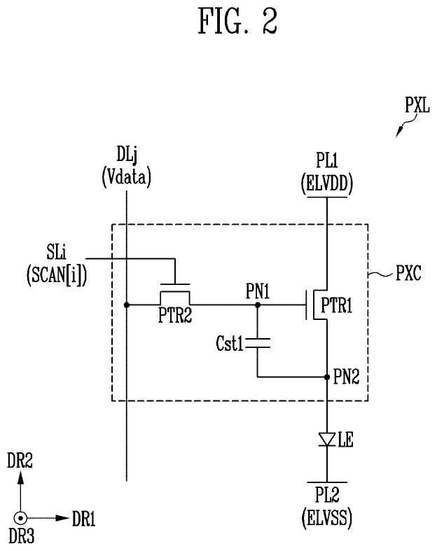

FIG. 2 is an equivalent schematic of a pixel PXL according to some example embodiments of the present disclosure.

Referring to FIG. 2, a pixel PXL according to some example embodiments of the present disclosure may include a pixel driving circuit PXC and a light emitting element LE.

The pixel driving circuit PXC may include two or more switching elements and one or more storage elements. In some example embodiments, the switching elements may be implemented as transistors. In some example embodiments, the storage element may be implemented as a capacitor.

In some example embodiments, the transistor may be implemented as a bipolar junction transistor (BJT), a field effect transistor (FET), or the like, but example embodiments of the present disclosure are not limited thereto.

Referring to FIG. 2, a pixel driving circuit PXC according to some example embodiments may include first and second pixel transistors PTR1, PTR2 and a storage capacitor Cst1 (e.g., a first storage capacitor Cst1). However, depending on the example embodiment, the pixel driving circuit PXC may include three or more transistors, or may include two or more capacitors.

The first pixel transistor PTR1 may include a gate electrode electrically connected with the first pixel node PN1. The first pixel transistor PTR1 may include a first electrode (e.g., any one of a source electrode and a drain electrode) in electrical connection with the first power line PL1, and a second electrode (e.g., any one of a source electrode and a drain electrode) in electrical connection with the light emitting element LE. The first pixel transistor PTR1 may provide the light emitting element LE with a driving current corresponding to a voltage applied to the first pixel node PN1. The first power line PL1 may be applied with a first power supply voltage ELVDD. The first power supply voltage ELVDD may be a high potential voltage.

The second pixel transistor PTR2 may be configured to switch the electrical connection between the j-th data line DLj and the first pixel node PN1 in response to a first scan signal SCAN[i] (also referred to below as the scan signal SCAN[i]) being applied to the i-th scan line SLi, where i is an integer greater than or equal to (or substantially equal to) 1. When the second pixel transistor PTR2 is turned on in response to a scan signal SCAN[i] at a turn-on level (e.g., a high level), the pixel driving circuit PXC may be written with a data voltage Vdata. The data voltage Vdata or a voltage corresponding to the data voltage Vdata may be applied to the first pixel node PN1.

The storage capacitor Cst1 may include a first electrode in electrical connection with the first pixel node PN1 and a second electrode in electrical connection with the second pixel node PN2. The second pixel node PN2 may be a node electrically connected with the first pixel transistor PTR1 and the light emitting element LE. In some example embodiments, the first electrode and the second electrode may be located on the same layer of the substrate SUB (see, e.g., FIG. 1). In other example embodiments, the first electrode and the second electrode may be located in different layers of the substrate SUB. In some example embodiments where the first electrode and the second electrode are located on different layers, the first electrode and the second electrode may be stacked perpendicular to each other. However, example embodiments of the present disclosure are not limited thereto.

The light emitting element LE may emit light in response to a drive current flowing to the first pixel transistor PTR1. The driving current may flow in the direction of the first power line PL1 to the second power line PL2. The light emitting element LE may include an anode electrode, a cathode electrode, and a light emitting layer. The anode electrode may be electrically connected to the first power line PL1. The cathode electrode may be electrically connected with the second power line PL2. In some example embodiments, the light emitting layer may be located between the anode electrode and the cathode electrode. According to some example embodiments, the light emitting layer may be implemented as an organic light emitting layer comprising an organic light emitting material. However, example embodiments of the present disclosure are not limited thereto, and the light emitting layer may include inorganic light emitting materials, quantum dots, nanorods, and the like. Referring to FIG. 2, an anode electrode may be electrically coupled to a second pixel node PN2.

Referring to FIG. 2, a pixel driving circuit PXC according to some example embodiments of the present disclosure may include a transistor comprising at least one N-type semiconductor. For example, at least one of the first pixel transistor PTR1, the second pixel transistor PTR2, and the third pixel transistor PTR3 may be implemented as a transistor comprising an N-type semiconductor. The transistor comprising an N-type semiconductor may be turned on in response to a high level of voltage and turned off in response to a low level of voltage. In some example embodiments, the transistor comprising the N-type semiconductor may be implemented as an NMOS transistor having an N-type channel. In some example embodiments, the transistor comprising the N-type semiconductor may be implemented as a transistor using a metal oxide semiconductor (e.g., Indium Gallium Zinc Oxide (IGZO)) as the active layer. However, example embodiments are not limited thereto.

On the other hand, the pixel PXL according to some example embodiments of the present disclosure is not limited to a structure having two transistors and one capacitor. According to some example embodiments, the scan signal SCAN[i] may be applied to a signal for controlling the emission timing of the light emitting element LE. According to some example embodiments, the scan signal SCAN[i] may be applied to a signal for controlling the timing at which an initialization voltage is applied to an anode electrode of the light emitting element LE. According to some example embodiments, the scan signal SCAN[i] may be applied to a signal for controlling the timing at which an initialization voltage is applied to the gate electrode of the first pixel transistor PTR1. Depending on the example embodiment, the scan signal SCAN[i] may be applied to a signal for controlling the timing at which a bias voltage is applied to the source electrode of the first pixel transistor PTR1. However, example embodiments of the present disclosure are not limited thereto.

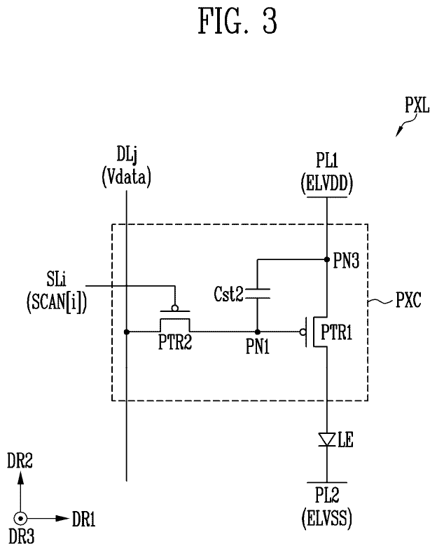

FIG. 3 is an equivalent schematic of a pixel PXL according to some example embodiments of the present disclosure.

Referring to FIG. 3, a pixel drive circuit PXC according to some example embodiments of the present disclosure may include a first pixel transistor PTR1, a second pixel transistor PTR2, and a storage capacitor Cst2.

Compared to some example embodiments as seen in FIG. 2, at least one of the first pixel transistor PTR1 and the second pixel transistor PTR2 may be implemented as a transistor comprising a P-type semiconductor. The transistor comprising a P-type semiconductor may be turned on in response to a low-level voltage and turned off in response to a high-level voltage. In some example embodiments, the transistor comprising the P-type semiconductor may be implemented as a PMOS transistor with a metal-oxide-semiconductor (MOS) structure having a P-type channel. In some example embodiments, the transistor comprising the P-type semiconductor can be implemented as a transistor using silicon as an active layer, such as amorphous silicon (a-Si), low-temperature polycrystalline silicon (LTPS), or the like. However, example embodiments are not limited thereto.

The first pixel transistor PTR1 may include a gate electrode electrically connected with the first pixel node PN1. The first pixel transistor PTR1 may include a first electrode (e.g., any one of a source electrode and a drain electrode) in electrical connection with the first power line PL1, and a second electrode (e.g., any one of a source electrode and a drain electrode) in electrical connection with the light emitting element LE. The first pixel transistor PTR1 may provide the light emitting element LE with a drive current corresponding to a voltage applied to the first pixel node PN1. The first power line PL1 may be applied with a first power supply voltage ELVDD. The first power supply voltage ELVDD may be a high potential voltage.

The second pixel transistor PTR2 may be configured to switch an electrical connection between the j-th data line DLj and the first pixel node PN1 in response to a scan signal SCAN[i] applied to the i-th scan line SLi, where i is an integer greater than or equal to (or substantially equal to) one. When the second pixel transistor PTR2 is turned on in response to the scan signal SCAN[i] at a turn-on level (e.g., low level), the data voltage Vdata or a voltage corresponding to the data voltage Vdata may be applied to the first pixel node PN1.

In some example embodiments, the storage capacitor Cst2 (e.g., the second storage capacitor Cst2) may include a first electrode in electrical connection with the first pixel node PN1 and a second electrode in electrical connection with the third pixel node PN3. The third pixel node PN3 may be the node to which the source electrode of the first pixel transistor PTR1 and the first power line PL1 are connected.

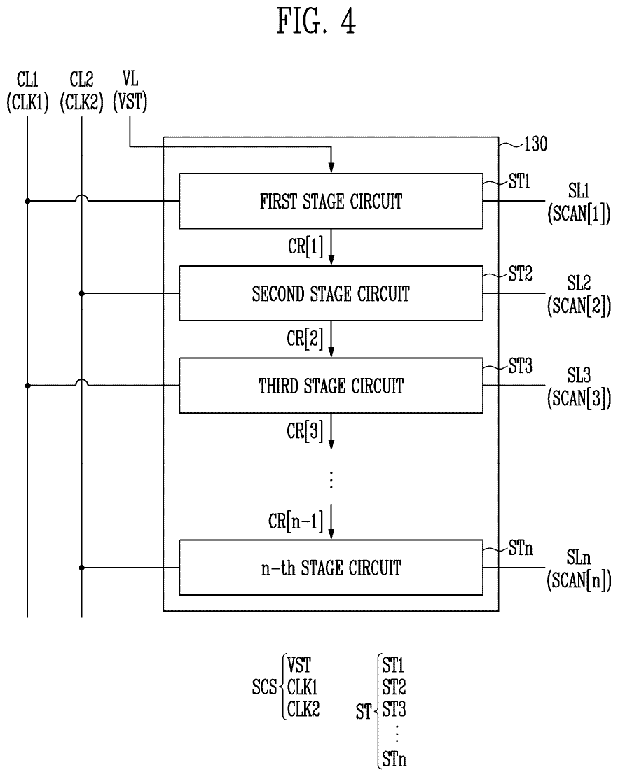

FIG. 4 is a block diagram of a scan driving circuit 130 according to some example embodiments of the present disclosure.

Referring to FIG. 4, the scan driving circuit 130 according to some example embodiments of the present disclosure may include stage circuits ST.

In some example embodiments, the stage circuits ST may include first to n-th stage circuits ST1, ST2, ST3, . . . , STn (hereinafter ST1 to STn).

The first to nth stage circuits ST1 to STn may be connected to a corresponding one of the first to n-th injection lines SL1 to SLn. The first to n-th stage circuits ST1 to STn may output any one of the first to n-th scan signals SCAN[1], SCAN[2], SCAN[3], . . . , SCAN[n] (hereinafter SCAN[1] to SCAN[n]).

The first to n-th scan signals SCAN[1] to SCAN[n] may have a turn-on level or a turn-off level. Depending on the example embodiment, the turn-on level may be one of a high level and a low level. The turn-off level may be the other of the high-level and the low-level.

The scan driving circuit 130 may be coupled to a first clock line CL1, a second clock line CL2, and a start line VL. The first clock line CL1 may have a first clock signal CLK1 applied to it. The second clock line CL2 may have a second clock signal CLK2 applied to it. A start signal VST may be applied to the start line VL. The first clock signal CLK1, the second clock signal CLK2, and the start signal VST may be included in the scan driving circuit control signal SCS.

In some example embodiments, the first stage circuit ST1 may be electrically connected to the first clock line CL1 and the start line VL. The first stage circuit ST1 may output a first scan signal SCAN[1] to the first scan line SL1. The first stage circuit (ST1) may output a first carry signal CR[1].

In some example embodiments, the second stage circuit ST2 may be electrically coupled to the second clock line CL2. The second stage circuit ST2 may receive a first carry signal CR[1] input from the first stage circuit ST1. The second stage circuit ST2 may output a second scan signal SCAN[2] to the second scan line SL2. The second stage circuit ST2 may output a second carry signal CR[2].

In some example embodiments, the third stage circuit ST3 may be electrically coupled to the first clock line CL1. The third stage circuit ST3 may receive a second carry signal CR[2] from the second stage circuit ST2. The third stage circuit ST3 may output a third scan signal SCAN[3] to the third scan line SL3. The third stage circuit ST3 may output a third carry signal CR[3].

In some example embodiments, the n-th stage circuit STn may be electrically coupled to the second clock line CL2. The n-th stage circuit STn may receive a first (n−1)-th carry signal CR[n−1] input from the (n−1)-th stage circuit. The n-th stage circuit STn may output an n-th scan signal SCAN[n] to the n-th scan line SLn.

In some example embodiments, an odd numbered stage circuit of the first to n-th stage circuits ST1 to STn may be electrically connected to the first clock line CL1. In some example embodiments, an even numbered stage circuit of the first to n-th stage circuits ST1 to STn may be electrically connected with the second clock line CL2.

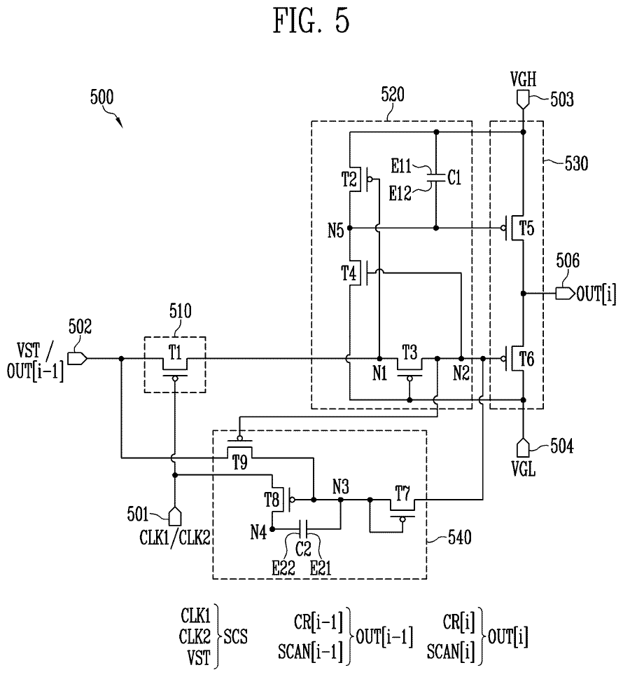

FIG. 5 is an equivalent schematic of a stage circuit 500 according to some example embodiments of the present disclosure.

Referring to FIG. 5, the stage circuit 500 according to some example embodiments of the present disclosure may include an input circuit 510, a signal processing circuit 520, an output circuit 530, and a stabilizing circuit 540.

In some example embodiments, the input circuit 510 may include a first transistor T1. The signal processing circuit 520 may include a second transistor T2, a third transistor T3, a fourth transistor T4, and a first capacitor C1. The output circuit 530 may include a fifth transistor T5 and a sixth transistor T6. The stabilizing circuit 540 may include a seventh transistor T7, an eighth transistor T8, a ninth transistor T9, and a second capacitor C2.

The first transistor T1 may include a gate electrode electrically connected to a first input terminal 501. The first transistor T1 may be configured to switch an electrical connection between a second input terminal 502 and the first node N1 in response to a signal input to the first input terminal 501. A clock signal (e.g., any one of a first clock signal CLK1 and a second clock signal CLK2) may be input to the first input terminal 501. A start signal VST and an output signal OUT[i−1] of a previous stage (e.g., the (i−1)-th stage) may be input to the second input terminal 502. When the first transistor T1 is turned on, a signal input to the second input terminal 502 may be input to the first node N1. The first transistor T1 may be implemented as a transistor comprising a P-type semiconductor. The first transistor T1 may be turned on in response to a low level signal.

The second transistor T2 may include a gate electrode electrically connected to the first node N1. The second transistor T2 may be configured to switch an electrical connection between a third input terminal 503 and the fifth node N5 in response to a voltage on the first node N1. The third input terminal 503 may be input with a first voltage (e.g., a high-level voltage VGH). When the second transistor T2 is turned on, the voltage input to the third input terminal 503 may be applied to the fifth node N5. The second transistor T2 may be implemented as a transistor comprising a P-type semiconductor. The second transistor T2 may be turned on in response to a low level of voltage.

The third transistor T3 may include a gate electrode electrically connected to a fourth input terminal 504. The third transistor T3 may be configured to turn on in response to a voltage input to the fourth input terminal 504 to switch the electrical connection between the first node N1 and the second node N2. A second voltage (e.g., a low level voltage VGL) may be input to the fourth input terminal 504. When the third transistor T3 is turned on, the first node N1 and the second node N2 may be electrically connected. The third transistor T3 may be implemented as a transistor comprising a P-type semiconductor. The third transistor T3 may be turned on in response to a low level voltage VGL.

The fourth transistor T4 may include a gate electrode electrically connected to the second node N2. The fourth transistor T4 may be configured to turn on in response to a voltage applied to the second node N2 to switch an electrical connection between the fourth input terminal 504 and the fifth node N5. When the fourth transistor T4 is turned on, the fourth input terminal 504 and the fifth node N5 may be electrically connected. The fourth transistor T4 may be implemented as a transistor comprising an N-type semiconductor. The fourth transistor T4 may be turned on in response to a high level of voltage.

The first capacitor C1 may include a first electrode E11 to which a constant voltage is applied, and a second electrode E12 electrically connected to the fifth node N5. For example, the first electrode E11 may be electrically connected to the third input terminal 503, but example embodiments of the present disclosure are not limited thereto. The first capacitor C1 may be configured to maintain a potential difference between the voltage applied to the first electrode E11 and the voltage applied to the second electrode E12.

The fifth transistor T5 may include a gate electrode electrically connected to the fifth node N5. The fifth transistor T5 may be configured to switch an electrical connection between the third input terminal 503 and a first output terminal 506 in response to a voltage applied to the fifth node N5. When the fifth transistor T5 is turned on, an i-th output signal OUT[i] having a high-level voltage VGH may be output via the first output terminal 506. The fifth transistor T5 may be implemented as a transistor comprising a P-type semiconductor. The fifth transistor T5 may be turned on in response to a low-level voltage.

The sixth transistor T6 may include a gate electrode in electrical connection with the second node N2. The sixth transistor T6 may be configured to switch an electrical connection between the fourth input terminal 504 and the first output terminal 506 in response to a voltage applied to the second node N2. When the sixth transistor T6 is turned on, the i-th output signal OUT[i] having a low level voltage VGL may be output via the first output terminal 506. The sixth transistor T6 may be implemented as a transistor comprising a P-type semiconductor. The sixth transistor T6 may be turned on in response to the low-level voltage.

The seventh transistor T7 may include a gate electrode electrically connected to the third node N3. The seventh transistor T7 may be connected between the third node N3 and the second node N2. The seventh transistor T7 may be connected between the third node N3 and the second node N2 in the form of a diode. When the seventh transistor T7 is turned on, the second node N2 and the third node N3 may be electrically connected. The seventh transistor T7 may be implemented as a transistor comprising a P-type semiconductor. The seventh transistor T7 may be turned on in response to a low level voltage.

The eighth transistor T8 may include a gate electrode electrically connected to the third node N3. The eighth transistor T8 may be configured to switch an electrical connection between the first input terminal 501 and the fourth node N4 (or, the second electrode E22 of the second capacitor C2) in response to a voltage applied to the third node N3. When the eighth transistor T8 is turned on, the first input terminal 501 and the fourth node N4 may be electrically connected. The eighth transistor T8 may be implemented as a transistor comprising a P-type semiconductor. The eighth transistor T8 may be turned on in response to a low-level voltage.

The ninth transistor T9 may include a gate electrode in electrical connection with the second node N2. The ninth transistor T9 may be configured to switch an electrical connection between the second input terminal 502 and the third node N3 in response to a voltage applied to the second node N2. When the ninth transistor T9 is turned on, the second input terminal 502 and the third node N3 may be electrically connected. The ninth transistor T9 may be implemented as a transistor comprising a P-type semiconductor. The ninth transistor T9 may be turned on in response to a low level of voltage.

The second capacitor C2 may include a first electrode E21 in electrical connection with the third node N3 and a second electrode E22 in electrical connection with the fourth node N4 (or the eighth transistor T8). The second capacitor C2 may be configured to maintain a potential difference between the voltage applied to the third node N3 and the voltage applied to the fourth node N4.

At least one of the first to ninth transistors T1 to T9 described above may have a dual gate structure in which two sub-transistors are connected in series and the gate electrodes are connected in common.

Referring to FIG. 5, an (i−1)-th output signal OUT[i−1] of the (i−1)-th stage may function as an (i−1)-th carry signal CR[i−1] and an (i−1)-th scan signal SCAN[i−1]. The i-th output signal OUT[i] of the i-th stage may function as the i-th carry signal CR[i] and the i-th scan signal SCAN[i].

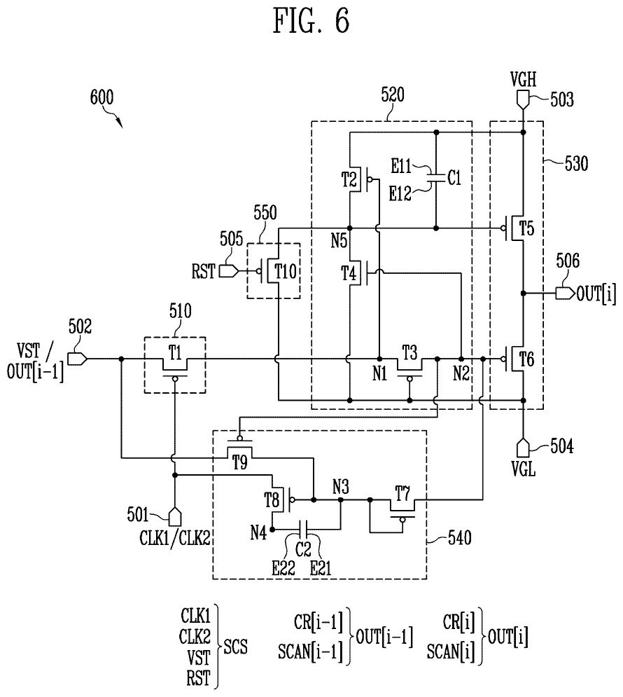

FIG. 6 is an equivalent schematic of a stage circuit 600 according to some example embodiments of the present disclosure.

Compared to FIG. 5, the stage circuit 600 according to the example embodiments as seen in FIG. 6 may further include a reset circuit 550.

The reset circuit 550 may include a tenth transistor T10.

The tenth transistor T10 may include a gate electrode electrically connected with a fifth input terminal 505. The tenth transistor T10 may be configured to switch an electrical connection between the fourth input terminal 504 and the fifth node N5 in response to a signal input to the fifth input terminal 505. A reset signal RST may be input to the fifth input terminal 505. The reset signal RST may be included in a scan driving circuit control signal SCS. When the tenth transistor T10 is turned on, the fourth input terminal 504 and the fifth node N5 may be electrically connected. The tenth transistor T10 may include a P-type semiconductor. The tenth transistor T10 may be turned on in response to a low-level signal. However, example embodiments of the present disclosure are not limited thereto, and the tenth transistor T10 may include an N-type semiconductor.

Referring further to FIGS. 1 and 4, the reset signal RST may be common to a plurality of stage circuits ST. When the electronic device DS is turned on, the reset signal RST at the turn-on level may be input to the scan driving circuit 130.

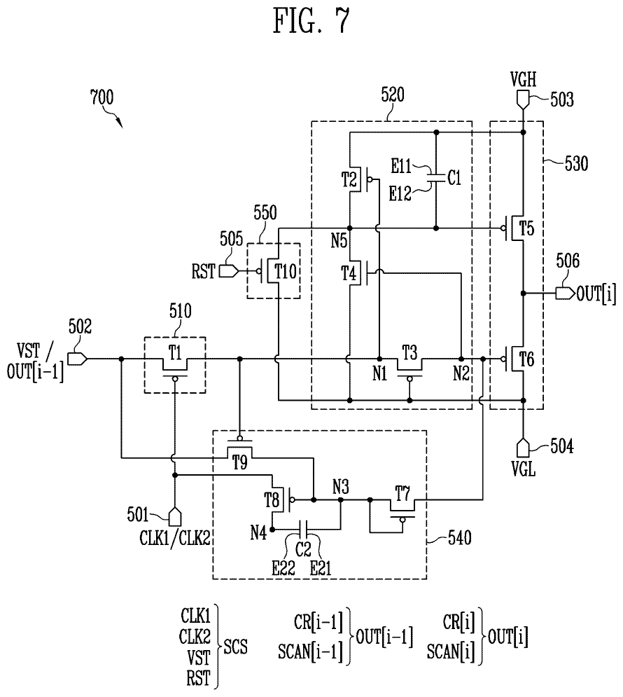

FIG. 7 is an equivalent schematic of a stage circuit 700 according to some example embodiments of the present disclosure.

Referring now to FIG. 7, some example embodiments are disclosed in which the gate electrode of the ninth transistor T9 is electrically connected to the first node N1 when compared to the example embodiments described in FIG. 6. In the above example embodiments, the ninth transistor T9 may be configured to switch an electrical connection between the second input terminal 502 and the third node N3 in response to a voltage applied to the first node N1.

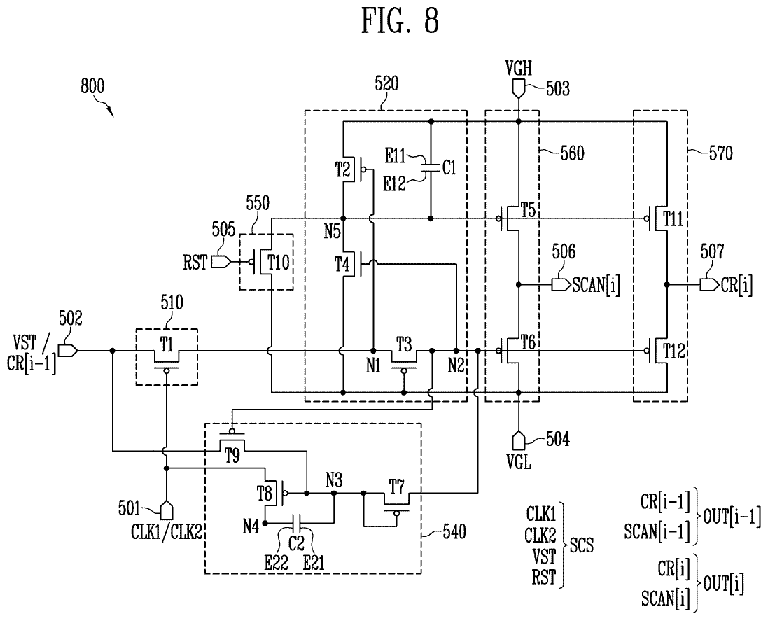

FIG. 8 is an equivalent schematic of a stage circuit 800, according to some example embodiments of the present disclosure.

Referring to FIG. 8, some example embodiments are disclosed in which the output circuit 530 is divided into a first output circuit 560 and a second output circuit 570 when compared to the example embodiments as seen in FIG. 6.

Referring to FIG. 8, the first output circuit 560 may include a fifth transistor T5 and a sixth transistor T6.

The fifth transistor T5 may be configured to switch an electrical connection between the third input terminal 503 and the first output terminal 506 in response to a voltage at the fifth node N5.

The sixth transistor T6 may be configured to switch an electrical connection between the fourth input terminal 504 and the first output terminal 506 in response to a voltage at the second node N2.

The first output terminal 506 may output a first scan signal SCAN[i].

The second output circuit 570 may include an eleventh transistor T11 and a twelfth transistor.

The eleventh transistor T11 may be configured to switch an electrical connection between the third input terminal 503 and a second output terminal 507 in response to a voltage at the fifth node N5. The eleventh transistor T11 may be implemented as a transistor comprising a P-type semiconductor. The eleventh transistor T11 may be turned on in response to a low level of voltage.

The twelfth transistor T12 may be configured to switch an electrical connection between the fourth input terminal 504 and the second output terminal 507 in response to a voltage at the second node N2. The twelfth transistor T12 may be implemented as a transistor comprising a P-type semiconductor. The twelfth transistor T12 may be turned on in response to a low level of voltage.

The second output terminal 507 may output a first carry signal CR[i].

A start signal VST or a first (i−1)-th carry signal CR[i−1] may be input to the second input terminal 502.

The (i−1)-th output signal OUT[i−1] may include the first (i−1)-th carry signal CR[i−1] and the first (i−1)-th scan signal SCAN[i−1].

The i-th output signal OUT[i] may include the i-th carry signal CR[i] and the i-th scan signal SCAN[i].

In some example embodiments, as seen in FIG. 8, the response speed of the scan driving circuit 130 (see, e.g., FIG. 1) may be improved as the outputs of the i-th scan signal SCAN[i] and the i-th carry signal CR[i] are decoupled.

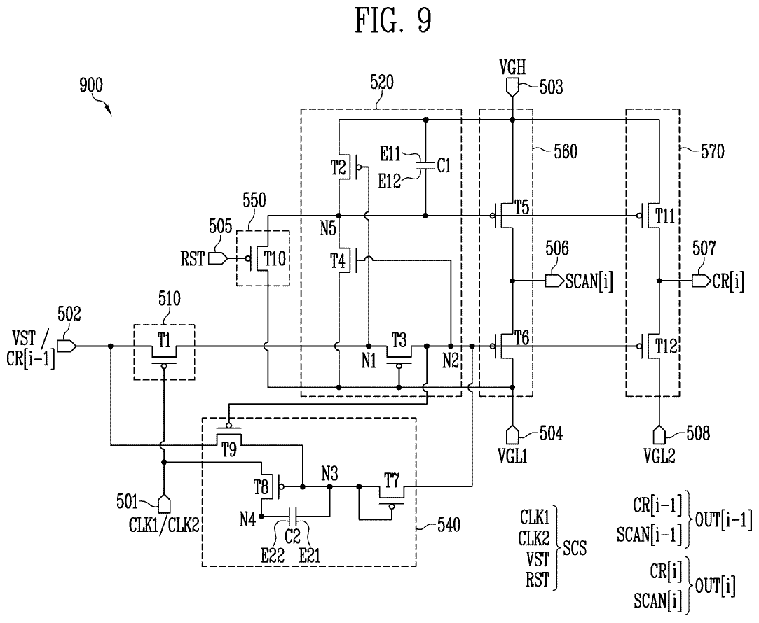

FIG. 9 is an equivalent schematic of a stage circuit 900 according to some example embodiments of the present disclosure.

Referring to FIG. 9, compared to some example embodiments as described in FIG. 8, a twelfth transistor T12 may be configured to switch the electrical connection between the sixth input terminal 508 and the second output terminal 507.

In the above example embodiments, the fourth input terminal 504 may be input with a first low level voltage VGL1. The sixth input terminal 508 may be input with a second low-level voltage VGL2.

In some example embodiments, the first low-level voltage VGL1 may be lower than the second low-level voltage VGL2. In some example embodiments, the first low-level voltage VGL1 may be higher than the second low-level voltage VGL2. In some other example embodiments, the first low-level voltage VGL1 and the second low-level voltage VGL2 may be substantially the same.

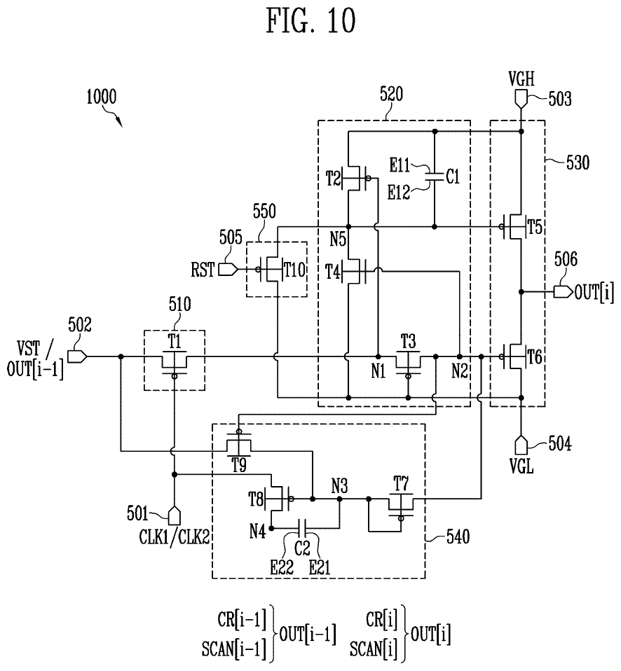

FIG. 10 is an equivalent schematic of a stage circuit 1000 according to some example embodiments of the present disclosure.

Referring to FIG. 10, compared to the example embodiments as described in FIG. 6, at least one of the first to tenth transistors T1 to T10 may be implemented as a four-terminal structure including a back-gate electrode. Accordingly, the phenomenon that the characteristic value of the transistor changes may be mitigated. Thereby, the visibility of the electronic device DS (see, e.g., FIG. 1) may be improved.

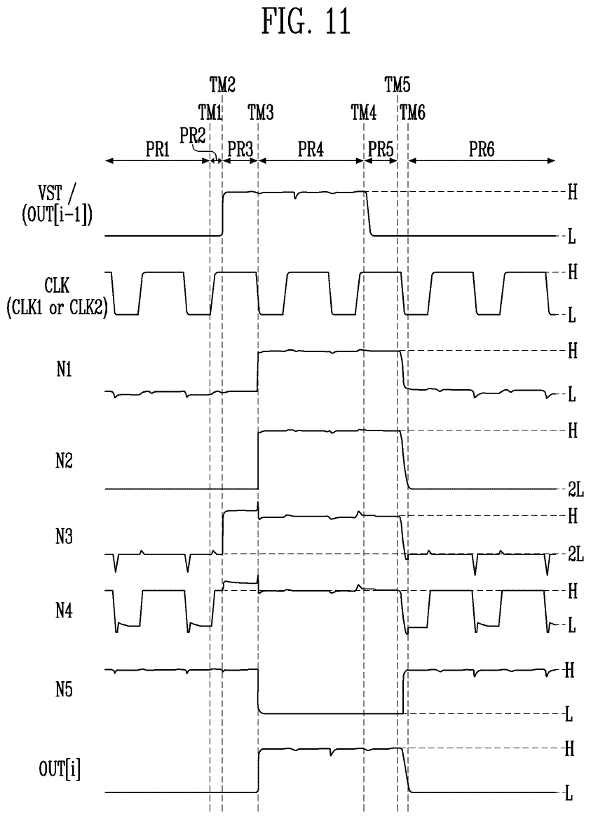

FIG. 11 is a timing diagram of a driving method according to some example embodiments of the present disclosure.

Referring to FIG. 11, an actuation method according to some example embodiments of the present disclosure may include a plurality of time periods separated by a desired (and/or alternatively predetermined) time point.

The desired (and/or alternatively predetermined) time points may be distinguished based on when the voltage of at least one of the first to fifth nodes N1 to N5 changes.

In the following, each of the nodes and signals is described as having a low level L, two low level 2L, or a high level H. This indicates the relative magnitude of the voltage over time at each of the nodes and signals.

The period before a first timing TM1 may be a first period PR1. The period between the first timing TM1 and a second timing TM2 may be a second period PR2. The period between the second time point TM2 and a third time point TM3 may be a third period PR3. The period between the third timing TM3 and a fourth timing TM4 may be a fourth period PR4. The period between the fourth timing TM4 and a fifth timing TM5 may be a fifth period PR5. The period after a sixth timing TM6 may be a sixth period PR6.

In the first period PR1, the start signal VST or the (i−1)-th output signal OUT[i−1] may have a low level L. The clock signal CLK of either the first clock signal CLK1 and the second clock signal CLK2 may be toggleable between a high level H and a low level L. The first node N1 may be applied a voltage at the low level L. The second node N2 may have a voltage of two low level 2L applied to it. The third node N3 can have a voltage of two low levels 2L applied to it overall. The fourth node N4 may have a low level L or a high level H voltage applied to it, depending on the clock signal CLK. The fifth node N5 may have an overall high level voltage applied to it. The output signal OUT[i] may have a low level L signal.

In the second period PR2, the start signal VST or the (i−1)-th output signal OUT[i−1] may have a low level L. The clock signal CLK may transition from the low level L to the high level H. The first node N1 may be applied a voltage at the low level L. The second node N2 may be applied a voltage of two low level 2L. The third node N3 may have a voltage of two low level 2L applied to it. The voltage applied to the fourth node N4 may be a transition from low level L to high level H. A voltage of the high level H may be applied to the fifth node N5. The i-th output signal OUT[i] may have a low level L.

In the third period PR3, the start signal VST or the (i−1)-th output signal OUT[i−1] may have a high level H. The clock signal CLK may have a high level (H). The first node N1 may have a low level voltage L applied to it. The second node N2 may have a voltage of two low level 2L applied to it. The third node N3 may have a voltage of high level H applied to it. The fourth node N4 may have a voltage of high level H applied to it. The fifth node N5 may be applied with a voltage of the high level H. The i-th output signal OUT[i] may have a high level H.

In the fourth period PR4, the start signal VST or the (i−1)-th output signal OUT[i−1] may have a high level H. The clock signal CLK may be toggled between the low level L and the high level H. The first node N1 may have a voltage of the high level H applied to it. The second node N2 may be applied a voltage of the high level H. The third node N3 may have a high-level H voltage applied to it. The fourth node N4 may have a high-level H voltage applied to it. A low level voltage L may be applied to the fifth node N5. The i-th output signal OUT[i] may have a high level (H).

In the fifth period PR5, the start signal VST or the (i−1)-th output signal OUT[i−1] may transit from a high level H to a low level L. The clock signal (CLK) may have a high level (H). The first node N1 may have a voltage at the high level H applied to it. The second node N2 may be applied a voltage of the high level H. The third node N3 may have a voltage of high level H applied to it. The fourth node N4 may have a voltage of high level H applied to it. The fifth node N5 may be applied a voltage of the low level L. The i-th output signal OUT[i] may have a high level H.

In the sixth period PR6, the start signal VST or the (i−1)-th output signal OUT[i−1] may have a low level L. The clock signal CLK may be toggled between the low level L and the high level H. The first node N1 may be applied a voltage of the low level L. The second node N2 may have a voltage of two low level 2L applied to it. The third node N3 can have a voltage of two low level 2L applied to it overall. The fourth node N4 may have a low level L or a high level H voltage applied to it, depending on the clock signal CLK. The fifth node N5 may have an overall high level voltage applied to it. The i-th output signal OUT[i] may have a low level L signal.

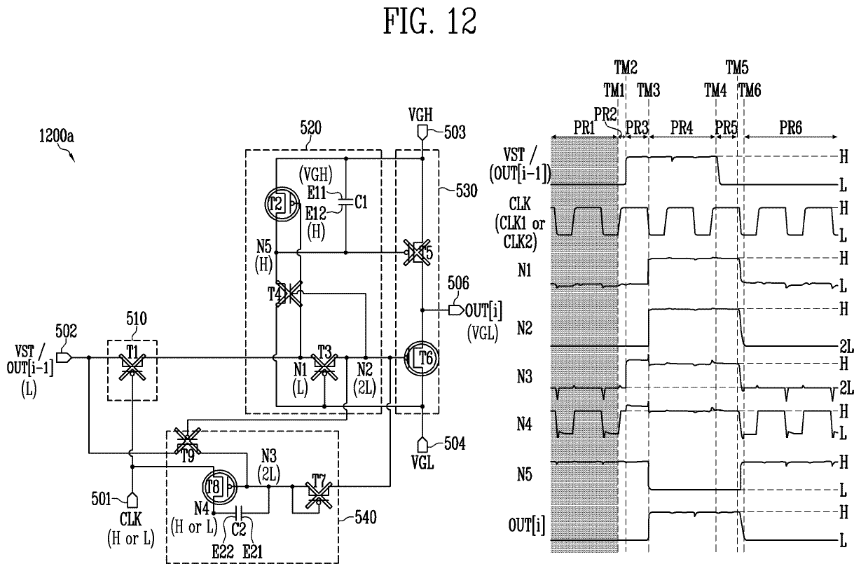

FIGS. 12 to 19 are drawings illustrating an equivalent schematic diagram of a stage circuit 1200a according to some example embodiments in association with a timing diagram of a driving method.

FIG. 12 focuses on the first period PR1.

Referring to FIG. 12, in the first period PR1, a clock signal CLK may be input to the gate electrode of the first transistor T1, wherein the clock signal CLK may have a high level H or a low level L. The first transistor T1 may be in a substantially current-free turn-off state. A voltage at the low level L is applied to both ends of the first transistor T1, whereby the first transistor T1 may be in a turn-off state where substantially no current flows. The first node N1 is applied with a voltage at the low level L. The second transistor T2 may be turned on. A low-level voltage VGL may be applied to the gate electrode of the third transistor T3. A voltage of low level L and a voltage of two low level 2L may be applied to both ends of the third transistor T3, whereby the third transistor T3 may be in a turn-off state in which substantially no current flows. The fourth transistor T4 may be turned off by applying a voltage of two low level 2L to the second node N2. A high-level voltage VGH is applied to the fifth node N5, and the fifth transistor T5 may be turned off. The sixth transistor T6 may be turned on in response to a voltage at the two low level 2L of the second node N2. The i-th output signal OUT[i] may have a low level voltage VGL. The ninth transistor T9 may have a gate electrode connected with the second node N2, and a voltage of the two low level 2L may be applied to the gate electrode. The ninth transistor T9 may have a low level L and a voltage of two low levels 2L applied to both ends, whereby the ninth transistor T9 may be in a turn-off state where substantially no current flows. The third node N3 may be applied a voltage of two low levels 2L. The eighth transistor T8 may be turned on in response to the voltage at the third node N3. A voltage of a high level H or a low level L may be applied to the fourth node N4 depending on the level of the clock signal CLK. A voltage of two low level 2L may be applied to both ends and gate electrodes of the seventh transistor T7.

For ease of explanation, the voltage at the first node N1 is described as being low level L. However, considering the threshold voltage of the first transistor T1, the voltage at the first node N1 in the first period PR1 can be expressed as the following Equation 1.

N1=L−Vth of T1 [symbol] L [Equation 1]

In Equation 1, N1 refers to the voltage at the first node N1. L refers to the voltage at the low level L input to the second input terminal 502. Vth of T1 refers to the threshold voltage of the first transistor T1. Below, for ease of explanation, the low-level voltage applied to the first node N1 is written as “L” without considering the threshold voltage of the first transistor T1.

On the other hand, for ease of explanation, the voltage at the third node N3 is described as two low level 2L. To briefly describe the process of reducing the voltage of the third node N3 to two low level 2L, it is as follows.

First, as the voltage input to the second input terminal 502 is decreased from the high level H to the low level L, the third node N3 may be applied a voltage as shown in the following equation 2.

N3′=L−Vth of T9 [symbol] L [Equation 2]

In Equation 2, N3′ refers to the voltage that is first applied to the third node N3. L refers to the voltage at the low level L of the signal input to the second input terminal 502. Vth of T9 refers to the threshold voltage of the ninth transistor T9. For ease of explanation, the threshold voltage of the ninth transistor T9 will be ignored below, and it will be explained that a voltage of the low level L is applied to the third node N3 first.

As described above, the third node N3 may be firstly applied a low level voltage L, which may turn on the eighth transistor T8. By a clock signal CLK input to the first input terminal 501, a high-level voltage H may be applied to the fourth node N4. Accordingly, a voltage of the high level H and a voltage of the low level L are applied to both ends of the second capacitor C2, respectively.

Next, when the voltage of the clock signal CLK input to the first input terminal 501 transitions from the high level H to the low level L, the voltage of the fourth node N4 decreases from the high level H to the low level L, and the voltage of the third node N3 may be lower than the low level L due to the coupling effect of the second capacitor C2. For example, a voltage may be applied to the third node N3 as shown in the following Equation 3.

N3=2L [Equation 3]

In Equation 3, N3 refers to the voltage applied secondary to (or converging on) the third node N3. 2L refers to a voltage level corresponding to two low level 2L, which may be approximately twice the voltage level to which low level L refers.

On the other hand, for convenience of explanation, the voltage of the second node N2 is described as being two low levels 2L, such as the voltage of the third node N3. However, considering the threshold voltage of the seventh transistor T7, a voltage may be applied to the second node N2 as shown in Equation 4 below.

N2=N3−Vth of T7=2L−Vth of T7 [Equation 4]

In Equation 4, “N2” refers to the voltage at the second node N2. “N3” and “2L” refer to the voltage applied to the third node N3. Vth of T7 refers to the threshold voltage of the seventh transistor T7. When the seventh transistor T7 is diode-connected so that the third node N3 and the second node N2 are electrically connected, a voltage as shown in Equation 4 is applied to the second node N2, and the seventh transistor T7 remains in a turn-off state where substantially no current flows. The voltage value of the second node N2, “N3-Vth of T7” (or, “2L-Vth of T7”), described by Equation 4, may be approximately twice the voltage value of the first node N1, “L-Vth of T1”, described by Equation 1. For simplicity of explanation, the voltage at the second node N2 is described below as being equal to (or substantially equal to) the voltage at the third node N3 and as being two low level 2L, which is twice the voltage value at the first node N1.

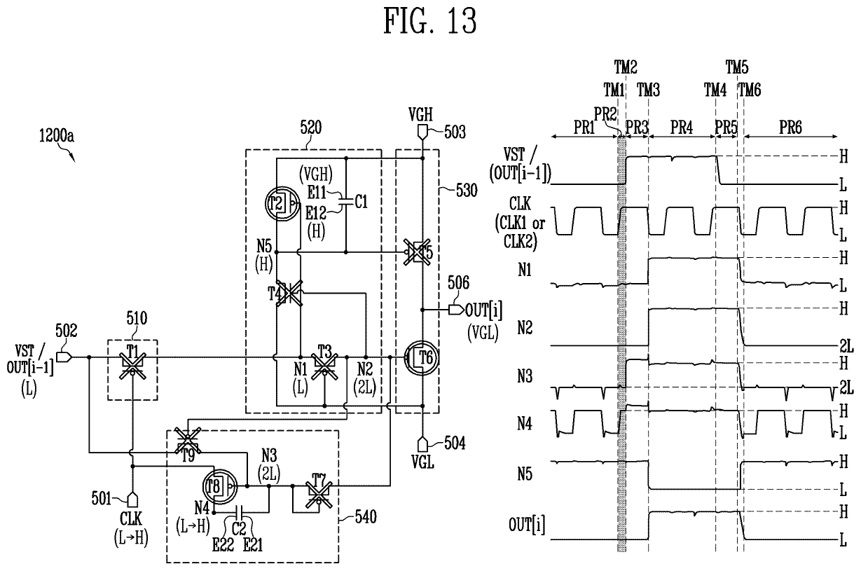

FIG. 13 focuses on the second period PR2.

Referring to FIG. 13, in the second period PR2, the first transistor T1 may be turned off in response to a clock signal CLK at the high level H. A low level voltage L is applied to the first node N1. The second transistor T2 may be turned on. A low-level voltage VGL may be applied to the gate electrode of the third transistor T3. The third transistor T3 may be turned off as a voltage of low level L and a voltage of two low levels 2L are applied to both ends, respectively. The fourth transistor T4 may be turned off by applying a voltage of two low level 2L to the second node N2. A high-level voltage VGH is applied to the fifth node N5, and the fifth transistor T5 may be turned off. The sixth transistor T6 may be turned on in response to a voltage at the two low level 2L of the second node N2. The i-th output signal OUT[i] may have a low level voltage VGL. The ninth transistor T9 may have a voltage of two low level 2L applied to the second node N2 connected to the gate electrode. The ninth transistor T9 may have a low level L and a voltage of two low levels 2L applied to both ends, and may be in a turn-off state where substantially no current flows. The third node N3 may have a voltage of two low level 2L applied to it. The eighth transistor T8 may be turned on in response to the voltage of the two low level 2L on the third node N3. The voltage of the fourth node N4 may be raised from the low level L to the high level H by a clock signal CLK. A voltage of two low level 2L may be applied to both ends of the seventh transistor T7, and the seventh transistor T7 may be in a turn-off state where substantially no current flows.

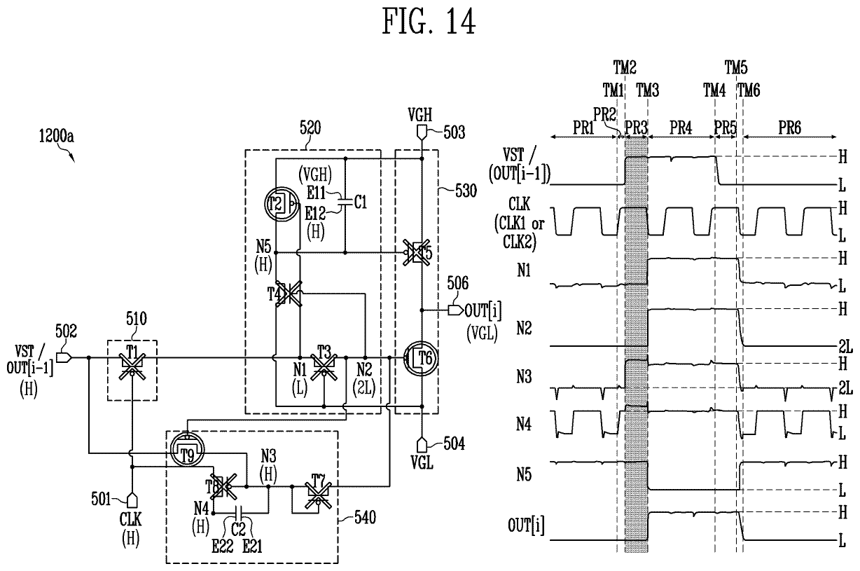

FIG. 14 focuses on the third period PR3.

Referring to FIG. 14, in the third period PR3, the first transistor T1 may be turned off in response to a clock signal CLK at the high level H. A low level voltage L is applied to the first node N1. The second transistor T2 may be turned on. The third transistor T3 may be in a turn-off state with a voltage of low level L and two low level 2L applied to both ends, such that substantially no current flows through it. The fourth transistor T4 may be turned off by applying a voltage of two low level 2L to the second node N2. A high-level voltage VGH is applied to the fifth node N5, and the fifth transistor T5 may be turned off. The sixth transistor T6 may be turned on in response to a voltage at the two low levels 2L of the second node N2. The i-th output signal OUT[i] may have a low level voltage VGL. The ninth transistor T9 may be turned on in response to a voltage of the two low level 2L of the second node N2. The third node N3 may have a voltage of a high level H applied to it. The eighth transistor T8 may be turned off in response to the voltage at the third node N3. The voltage on the fourth node N4 may be maintained at the high level H. The gate electrode of the seventh transistor T7 may be turned off by applying a voltage at the high level H to it.

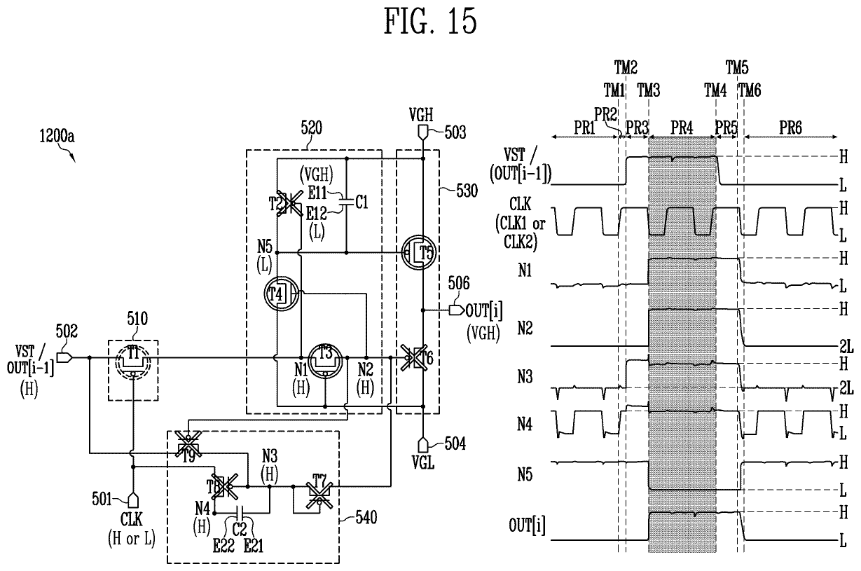

FIG. 15 focuses on the fourth period PR4.

Referring to FIG. 15, in the fourth period PR4, the first transistor T1 may be turned on or turned off in response to a clock signal CLK having a low level L or a high level H. The first node N1 may be applied a voltage at the high level H. The second transistor T2 may be turned off. The third transistor T3 may be turned on in response to a low-level voltage VGL. The fourth transistor T4 may be turned on in response to a high-level voltage H being applied to the second node N2. The fifth node N5 has a low level L, which may be equal to (or substantially equal to) a low level voltage VGL applied to the fourth input terminal 504. The fifth transistor T5 may be turned on in response to a voltage at the fifth node N5 having a low level L. The sixth transistor T6 may be turned off in response to a voltage of the second node N2 having a high level H. The i-th output signal OUT[i] may have a high-level voltage VGH. The ninth transistor T9 may be turned off in response to a voltage of the second node N2 having a high level H. The third node N3 may have a voltage at the high level H. The eighth transistor T8 may be turned off in response to the voltage of the third node N3 having the high level H. The voltage at the fourth node N4 may be maintained at the high level H. The gate electrode of the seventh transistor T7 may be turned off by applying a voltage of the high level H to it.

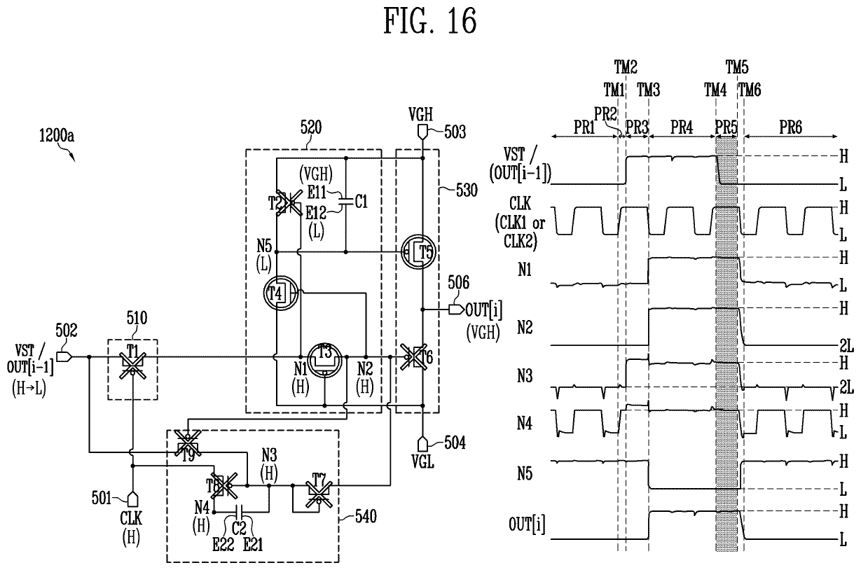

FIG. 16 focuses on the fifth period PR5.

Referring to FIG. 16, in the fifth period PR5, the first transistor T1 may be turned off in response to a clock signal CLK at the high level H. The start signal VST or the (i−1)-th output signal OUT[i−1] may transition from the high level H to the low level L. The first node N1 may have a voltage at the high level H maintained. The second transistor T2 may be turned off. The third transistor T3 may be turned on in response to the low-level voltage VGL. The fourth transistor T4 may be turned on in response to a high-level voltage H being applied to the second node N2. The fifth node N5 may have a low level voltage L applied to it. In response to the voltage at the fifth node N5 having the low level L, the fifth transistor T5 may be turned on. The sixth transistor T6 may be turned off in response to a voltage of the second node N2 having a high level H. The i-th output signal OUT[i] may have a high-level voltage VGH. The ninth transistor T9 may be turned off in response to a voltage of the second node N2 having a high level H. The third node N3 may have a voltage at the high level H. The eighth transistor T8 may be turned off in response to the voltage of the third node N3 having the high level H. The voltage at the fourth node N4 may be maintained at the high level H. The gate electrode of the seventh transistor T7 may be turned off by applying a voltage of the high level H to it.

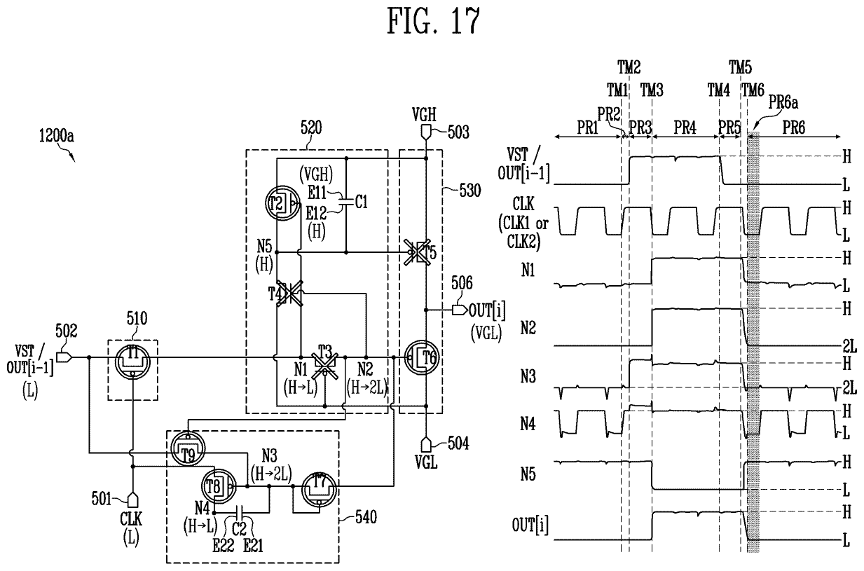

FIG. 17 focuses on a 6a-th period PR6a of the sixth period 6 PR6.

Referring to FIG. 17, in 6a-th period PR6a, the first transistor T1 may be turned on in response to a clock signal CLK at a low level L. The start signal VST or the (i−1)-th output signal OUT[ip−1] may have a low level L. The voltage of the first node N1 may decrease from the high level H to the low level L. The specific voltage level of the first node N1 is as described above via Equation 1. The voltage level of the second node N2 may be lowered from the high level H to the two low level 2L, as described previously via Equation 4. The fourth transistor T4 may be turned off in response to the voltage of the second node N2 having the two low level 2L. The third transistor T3 may be in a turn off state with a voltage of low level L and two low level 2L applied to both ends, such that substantially no current flows. The fifth node N5 may have a voltage of a high level H applied to it. In response to the voltage at the fifth node N5 having the high level H, the fifth transistor T5 may be turned off. The sixth transistor T6 may be turned on in response to a voltage at the two low level 2L of the second node N2. The i-th output signal OUT[i] may have a low level voltage VGL. The ninth transistor T9 may be turned on in response to a voltage of the second node N2 having two low level 2L. The voltage of the third node N3 may be reduced from the high level H to the two low level 2L, the process being as described above via Equation 2 and Equation 3. The eighth transistor T8 may be turned on in response to the voltage of the third node N3 having the two low level 2L. The voltage of the fourth node N4 may transition from a high level H to a low level L in response to a clock signal CLK. The gate electrode of the seventh transistor T7 may have a voltage applied that decreases from the high level H to the two low level 2L, whereby the seventh transistor T7 may be turned on. Accordingly, the second node N2 and the third node N3 may be electrically connected.

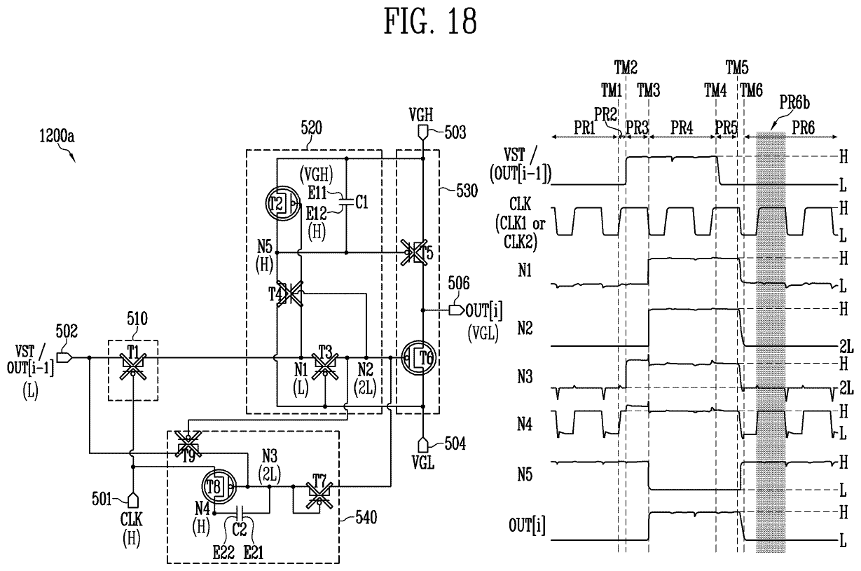

FIG. 18 focuses on 6b-th period PR6b of the sixth period PR6.

Referring to FIG. 18, in 6b-th period PR6b, the first transistor T1 may be turned off by inputting a high level clock signal CLK to the gate electrode. A low level voltage L is applied to the first node N1. The second transistor T2 may be turned on in response to the voltage of the first node N1 having the low level L. A low level voltage VGL may be applied to the gate electrode of the third transistor T3. Both ends of the third transistor T3 may have a low level L and two low level 2L voltages applied to them so that they are in a turn-off state where substantially no current flows. The fourth transistor T4 may be turned off by applying a voltage of two low level 2L to the second node N2. A high level voltage VGH is applied to the fifth node N5, and the fifth transistor T5 may be turned off. The sixth transistor T6 may be turned on in response to a voltage at the two low level 2L of the second node N2. The i-th output signal OUT[i] may have a low level voltage VGL. A voltage of two low level 2L may be applied to the gate electrode of the ninth transistor T9. The ninth transistor T9 may be in a turn-off state with a low level L and a voltage of two low levels 2L applied to both ends, such that substantially no current flows. The third node N3 may have a voltage of two low level 2L applied to it. The eighth transistor T8 may be turned on in response to the voltage at the third node N3 having two low level 2L. The fourth node N4 may be applied a voltage with a high level H in response to a clock signal CLK. Both ends of the seventh transistor T7 may have a voltage of two low level 2L applied to them and may be in a turn-off state where substantially no current flows.

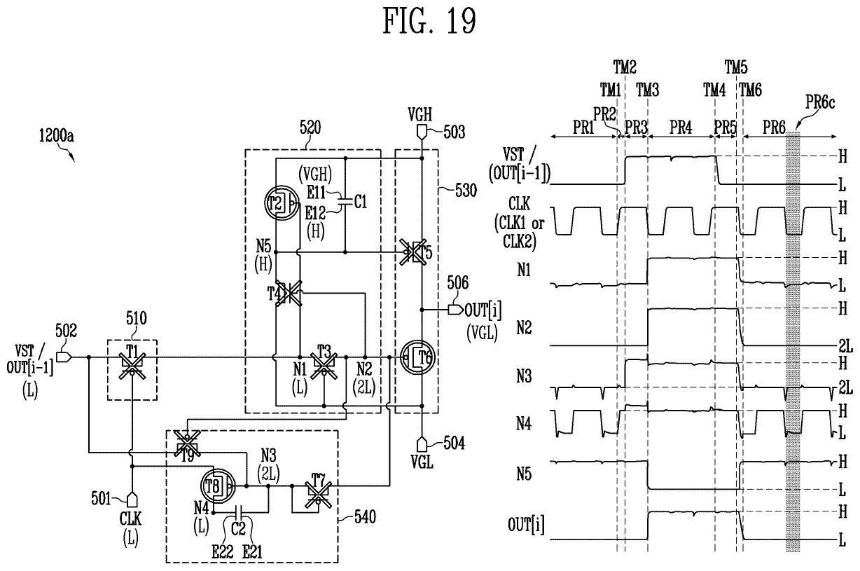

FIG. 19 focuses on 6c-th period PR6c of the sixth period PR6.

Referring to FIG. 19, in the 6c-th period PR6c, the first transistor T1 may apply a clock signal CLK with a low level L to the gate electrode. The start signal VST or the (i-1)-th output signal OUT[i−1] may have a low level L. The first transistor T1 may be in a turn off state with a voltage of the low level L applied to both ends and substantially no current flowing. The voltage at the first node N1 may be at the low level L. The voltage level of the second node N2 may be two low levels 2L. The fourth transistor T4 may be turned off in response to the voltage of the second node N2 having two low levels 2L. The third transistor T3 may be in a turn off state with a voltage of low level L and two low levels 2L applied to both ends, such that substantially no current flows. The fifth node N5 may have a voltage of a high level H applied to it. In response to the voltage at the fifth node N5 having the high level H, the fifth transistor T5 may be turned off. The sixth transistor T6 may be turned on in response to a voltage at the two low levels 2L of the second node N2. The i-th output signal OUT[i] may have a low level voltage VGL. A voltage of two low level 2L may be applied to the gate electrode of the ninth transistor T9. The ninth transistor T9 may be in a turn-off state in which substantially no current flows, as a voltage of low level L and two low levels 2L is applied to both ends. The third node N3 may have a voltage of two low levels 2L applied to it. The eighth transistor T8 may be turned on in response to the voltage on the third node N3 having the two low levels 2L. The voltage of the fourth node N4 may have a low level L in response to a clock signal CLK. The seventh transistor T7 may have a voltage of two low levels 2L applied to both ends, and may be in a turn-off state where substantially no current flows.

Referring to FIG. 19, when the voltage of the second node N2 fluctuates at the two low level 2L, the seventh transistor T7 may be turned on again. When the seventh transistor T7 is turned on, the second node N2 and the third node N3 are electrically connected, whereby the voltage of the second node N2 can be stably maintained at the two low level 2L.

Referring to FIGS. 12 to 19, the stage circuit 1200a may include the stabilizing circuit 540. Thereby, the voltage at the second node N2 may be reduced to a two low level 2L that is lower than the low level L. By maintaining the level of the second node N2 at the two low level 2L, example embodiments of the present disclosure may improve control such that the i-th output signal OUT[i] is has improved stability.

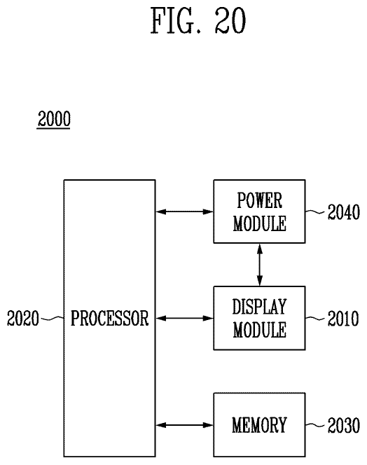

FIG. 20 is a block diagram of an electronic device 2000 according to some example embodiments of the present disclosure.

Referring to FIG. 20, an electronic device 2000 according to some example embodiments may include a display module 2010, a processor 2020, a memory 2030, and a power module 2040.

The processor 2020 may include at least one of a central processing unit (CPU), an application processor (AP), a graphic processing unit (GPU), a communication processor (CP), an image signal processor (ISP), and a controller.

The memory 2030 may store data information necessary for operation of the processor 2020 or the display module 2010. When the processor 2020 executes an application stored in the memory 2030, image data signals and/or input control signals are delivered to the display module 2010, and the display module 2010 may process the signals provided to output image information via the display screen.

The power module 2040 may include a power supply module, such as a power adapter or battery unit, and a power conversion module that converts power supplied by the power supply module to generate power for operation of the electronic device 2000.

At least one of each of the above-described configurations of the electronic device 2000 may be included within the display device 100 (see, e.g., FIG. 1) according to the above-described embodiments. Additionally, some of the individual modules that are functionally included within a single module may be included within the display device 100 and others may be provided separately from the display device 100. For example, display device 100 may include display module 2010, while processor 2020, memory 2030, and power module 2040 may be provided in the form of other devices within electronic device 2000 that are not display devices.

The processor 2020 according to some example embodiments of the present disclosure may include the aforementioned host HST (see, e.g., FIG. 1).

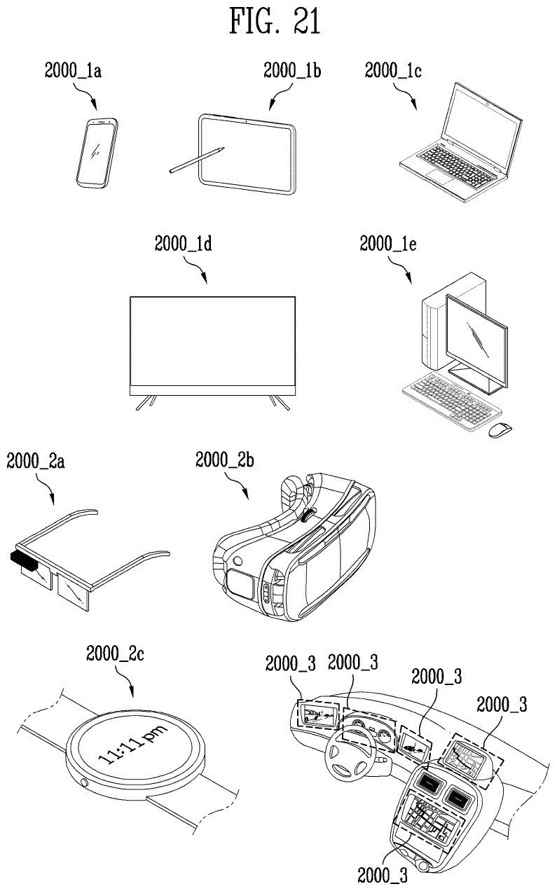

FIG. 21 is a schematic diagram of an electronic device according to various example embodiments.

Referring to FIG. 21, various electronic devices with display devices according to some example embodiments include electronic devices for displaying images, such as a smartphone 2000_1a, a tablet PC 2000_1b, a laptop 2000_1c, a television 2000_1d, a desk monitor 2000_1e, as well as wearable electronic devices including display modules such as smart glasses 2000_2a, a head-mounted display 2000_2b, and, a smart watch 2000_2c, and the like, and automotive (motor vehicles) electronic devices 2000_3 including display modules such as a dashboard, a center fascia, an instrument panel, a center information display CID arranged on the dashboard, a room mirror display.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

According to some example embodiments of the present disclosure, a stage circuit, a display device comprising the same, and an electronic device comprising the same can reliably control an output signal.

The foregoing referenced drawings and detailed description of the invention are merely exemplary and are intended to illustrate the invention and are not intended to limit the meaning or to restrict the scope of the invention as claimed in the appended patent claims. Accordingly, one having ordinary knowledge in the art will understand that various modifications and other equally valid embodiments are possible therefrom. Accordingly, the true scope of technical protection of the invention should be determined by the technical ideas of the appended patent claims.

What is claimed is:

1. A stage circuit comprising:
an input circuit configured to input a first signal from a first input terminal to a first node in response to a clock signal input to a second input terminal;
a signal processing circuit configured to
switch an electrical connection between a third input terminal and a second node in response to a voltage of the first node, and
switch an electrical connection between a fourth input terminal and the second node in response to a voltage of a third node, the third node being electrically connected to the first node;
an output circuit configured to
switch an electrical connection between the third input terminal and an output terminal in response to a voltage of the second node, and
switch an electrical connection between the fourth input terminal and the output terminal in response to the voltage of the third node; and
a stabilizing circuit configured to
switch an electrical connection between the first input terminal and a fourth node in response to the voltage of the first node or the voltage of the third node, and
switch an electrical connection between the second input terminal and a fifth node in response to a voltage of the fourth node, wherein the fourth node and the third node are electrically connected.

2. The stage circuit according to claim 1, wherein the input circuit includes:
a first input transistor comprising a gate electrode electrically connected to the second input terminal, and configured to switch an electrical connection between the first input terminal and the first node.

3. The stage circuit according to claim 1, wherein
the second input terminal is configured to receive a clock signal, and
the first input terminal is configured to receive at least one of a start signal and an output signal of a previous stage.

4. The stage circuit according to claim 1, wherein the signal processing circuit comprises:
a first signal processing transistor comprising a gate electrode electrically connected to the first node, and the first signal processing transistor configured to switch the electrical connection between the third input terminal and the second node;
a second signal processing transistor comprising a gate electrode electrically connected to the fourth input terminal, and configured to switch an electrical connection between the first node and the third node;
a third signal processing transistor comprising a gate electrode electrically connected to the third node, and configured to switch the electrical connection between the fourth input terminal and the second node; and
a first capacitor comprising a first electrode configured to receive a constant voltage and a second electrode electrically connected to the second node.

5. The stage circuit according to claim 4, wherein the first electrode of the first capacitor is electrically connected to the third input terminal.

6. The stage circuit according to claim 4, wherein the first signal processing transistor and the second signal processing transistor comprise P-type semiconductors, and the third signal processing transistor comprises an N-type semiconductor.

7. The stage circuit according to claim 1, wherein the third input terminal is configured to receive a high level voltage and the fourth input terminal is configured to receive a low level voltage.

8. The stage circuit according to claim 1, further comprising:
a reset circuit configured to switch the electrical connection between the fourth input terminal and the second node in response to a signal input to a fifth input terminal.

9. The stage circuit according to claim 8, wherein the reset circuit comprises:
a first reset transistor configured to switch the electrical connection between the fourth input terminal and the second node in response to a reset signal input to the fifth input terminal.

10. The stage circuit according to claim 1, wherein the output circuit comprises:
a first output transistor comprising a gate electrode electrically connected to the second node, and configured to switch the electrical connection between the third input terminal and the output terminal; and
a second output transistor comprising a gate electrode connected to the third node, and configured to switch the electrical connection between the fourth input terminal and the output terminal.

11. The stage circuit according to claim 1, wherein the output circuit includes a first output circuit and a second output circuit, and the output terminal includes a first output terminal and a second output terminal,
wherein the first output circuit comprises
a first output transistor comprising a gate electrode electrically connected to the second node, and the first output transistor configured to switch an electrical connection between the third input terminal and the first output terminal, and
a second output transistor comprising a gate electrode electrically connected to the third node, and configured to switch an electrical connection between the fourth input terminal and the first output terminal, and
wherein the second output circuit comprises
a third output transistor comprising a gate electrode electrically connected to the second node, the third output transistor configured to switch an electrical connection between the third input terminal and the second output terminal, and
a fourth output transistor comprising a gate electrode electrically connected to the third node, the fourth output transistor configured to switch an electrical connection between the fourth input terminal and the second output terminal.

12. The stage circuit according to claim 11, wherein
the first output terminal outputs an i-th scan signal,
the second output terminal is output with an i-th carry signal, and
i is an integer greater than or equal to 1.

13. The stage circuit according to claim 1, wherein
the output circuit includes a first output circuit and a second output circuit,
the output terminal includes a first output terminal and a second output terminal,
the first output circuit comprises
a first output transistor comprising a gate electrode electrically connected to the second node, and the first output transistor configured to switch an electrical connection between the third input terminal and the first output terminal, and
a second output transistor comprising a gate electrode electrically connected to the third node, and configured to switch an electrical connection between the fourth input terminal and the first output terminal, and
the second output circuit comprises
a third output transistor comprising a gate electrode electrically connected to the second node, and configured to switch an electrical connection between the third input terminal and the second output terminal, and
a fourth output transistor comprising a gate electrode electrically connected to the third node, and configured to switch an electrical connection between a sixth input terminal and the second output terminal.

14. The stage circuit according to claim 13, wherein
the fourth input terminal is configured to receive a first low level voltage, and
the sixth input terminal is configured to receive a second low level voltage, the second low level voltage different from the first low level voltage.

15. The stage circuit according to claim 1, wherein the stabilizing circuit comprises:
a first stabilizing transistor comprising a gate electrode electrically connected to the fourth node, and the first stabilizing transistor connected between the third node and the fourth node;
a second stabilizing transistor comprising a gate electrode electrically connected to the fourth node, and configured to switch the electrical connection between the second input terminal and the fifth node;
a third stabilizing transistor comprising a gate electrode electrically connected to any one of the first node and the third node, and configured to switch an electrical connection between the first input terminal and the fourth node; and
a second capacitor comprising a first electrode electrically connected to the fourth node and a second electrode electrically connected to the fifth node.

16. A display device comprising:
a display panel including a plurality of pixels;
a scan driving circuit comprising a plurality of stage circuits, the plurality of stage circuits configured to supply a scan signal to the plurality of pixels;
a data driving circuit configured to supply a plurality of data signals to the plurality of pixels; and
a timing controller configured to control the scan driving circuit and the data driving circuit,
wherein at least one of the plurality of stage circuits comprises
an input circuit configured to input a first signal from a first input terminal to a first node in response to a second signal input to a second input terminal,
a signal processing circuit configured to
switch an electrical connection between a third input terminal and a second node in response to a voltage of the first node, and
switch an electrical connection between a fourth input terminal and the second node in response to a voltage on a third node,
the third node being electrically connected to the first node,
an output circuit configured to
switch an electrical connection between the third input terminal and an output terminal in response to a voltage of the second node, and
switch an electrical connection between the fourth input terminal and the output terminal in response to a voltage of the third node, and
a stabilizing circuit configured to
switch an electrical connection between the first input terminal and a fourth node in response to the voltage of the first node or the voltage of the third node, and
switch an electrical connection between the second input terminal and a fifth node in response to the voltage of the fourth node, and
wherein the fourth node and the third node are electrically connected.

17. The display device according to claim 16, wherein the output terminal outputs the scan signal.

18. The display device according to claim 16, wherein at least one of the plurality of pixels comprises:
a light emitting element;
a first pixel transistor comprising a gate electrode electrically connected to a pixel node, and connected between a power line and the light emitting element; and
a second pixel transistor comprising a gate electrode electrically connected to a scan line, the scan line configured to receive the scan signal, and the second pixel transistor configured to switch an electrical connection between the pixel node and a data line, the data line configured to receive a data signal of the plurality of data signals.

19. An electronic device comprising:
a display device comprising
a plurality of pixels configured to display an image, and
a plurality of stage circuits configured to supply a scan signal to the plurality of pixels; and
a processor configured to control the display device,
wherein at least one of the plurality of stage circuits comprises
an input transistor configured to input a first signal from a first input terminal to a first node in response to a second signal input to a second input terminal,
a signal processing circuit configured to
switch an electrical connection between a third input terminal and a second node in response to a voltage of the first node, and
switch an electrical connection between a fourth input terminal and the second node in response to a voltage of a third node, the third node being electrically connected to the first node,
an output circuit configured to
switch an electrical connection between the third input terminal and an output terminal in response to a voltage of the second node, and
switch an electrical connection between the fourth input terminal and the output terminal in response to the voltage of the third node, and
a stabilizing circuit configured to
switch an electrical connection between the first input terminal and a fourth node in response to the voltage of the first node or the voltage of the third node, and
switch an electrical connection between the second input terminal and a fifth node in response to a voltage of the fourth node, and
wherein the fourth node and the third node are electrically connected.

20. The electronic device according to claim 19, wherein the electronic device comprises at least one of a smartphone, a tablet PC, a laptop, a television, a desk monitor, smart glasses, a head-mounted display, a smart watch, an instrument panel of a motor vehicle, a center fascia, a CID on a dashboard, and a room mirror display.
